(19) United States
(12) Patent Application Publication
(10) Pub. No.: US 2009/0119469 A1
(43) Pub. Date: May 7, 2009

(54) Procedure for Time-Limited Storage of Data on Storage Media

(76) Inventors: Nikolaus Dellantoni, Sooss (AT); Alfred Pohl, Mistelbach (AT)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/225,002

(22) PCT Filed: Dec. 4, 2006
(86) PCT No.: PCT/EP2006/069267

§ 371 Date: Sep. 11, 2008

(30) Foreign Application Priority Data
Mar. 31, 2006 (DE) 10 2006 015 063.5

(51) Int. Cl. G06F 12/00

(52) U.S. Cl. 711/166; 711/154; 711/E12.001

(57) ABSTRACT

There is described a procedure for temporally limiting the storage of data on storage media, in which the data are provided with an expiry date when being stored on a storage medium. When access is made to these data by a read/write device, the expiry date is compared with a current date. When the expiry date is reached or exceeded, a pre-specified action is initiated—for example the deletion of the data from the storage medium or access being made to the data only by authorization. Based upon the procedure it is possible, on the one hand, to easily render sensitive information such as personal data unusable upon expiration of a storage period, if for example the expiry date is set to coincide with the date when the storage period elapses. On the other hand, copyright and marketing rights for digital data can thereby be easily protected without the additional use of licensing servers of the installation of executable programs.

### CROSS REFERENCE TO RELATED APPLICATIONS

This application is the US National Stage of International Application No. PCT/EP2006/069267, filed Dec. 4, 2006 and claims the benefit thereof. The International Application claims the benefits of German application No. 10 2006 015 063.5 DE filed Mar. 31, 2006, both of the applications are incorporated by reference herein in their entirety.

### FIELD OF INVENTION

The invention relates to a procedure for time-limited storage of data on storage media.

### BACKGROUND OF INVENTION

In data processing data is understood to be representations of information able to be read and processed by a machine. Data in such cases is by definition mostly logically-grouped information units which are to be processed or transmitted between (computer) systems.

To enable data to be stored over the longer term for processing in a structured manner on so-called storage media such as hard disks, CD-ROM, DVD, flash memory, etc., so called file systems exist. The file system defines how data is able to be placed, stored and administered in the form of files on the storage medium. In such cases a file represents a volume of data able to be accessed in its entirety via a so-called file name and is considered by the file system as a unit.

The file system also defines the security able to be achieved—the so-called access rights—directory and also name conventions (e.g. length, suffixes, etc.) and the addressable storage space (such as smallest addressable unit, maximum storage space able to be administered for example). In addition associated identifying features for the stored files such as name, file size, creation date etc. for the stored files will be held on the storage medium.

The option of managing as well as that of processing data held in files is thus defined by the file system. Processing here is understood to be accessing of data stored in files, by programs for example during their execution or by hardware components. Processing further also comprises a correct Interpretation of this data by the program or hardware components.

Accessing or access will then for example refer to the reading out (read access) of data, held in a memory or in the form of a file on a storage medium for example, or the storage (write access) of data held in a memory or in the form of a file on a storage medium for example. The process of writing data into a file on storage media such as hard disk, CD-ROM, DVD, flash memory etc. can also be referred to as storage.

The term “storage” in information technology is generally taken to mean electronic, magnetic, nano-mechanical or optical media for short-term or longer-term recording of digital information or data. Using write access by a read/write facility, which comprises a so-called storage access microcontroller as a hardware/firmware part for controlling write access for example, the data can be entered into the storage (or read in or “written in”). With a read access by a read/write device data is retrieved or read out from the storage. Technical parameters such as storage capacity, access time and the medium used for the storage (e.g. magnetic tape or disk medium or optical medium) are usually employed for the technical description of storage.

Storage can be classified in different ways, such with reference to the volatility of the data for example. In such cases a distinction is made between so-called volatile and non-volatile or permanent storage. With so-called volatile storage the storage content is lost after the supply voltage is switched off, which means that said storage is not able to be used for longer-term storage. Volatile storage such as Random Access Memories (RAMs) for example which are used as the main memory in a computer, or so-called cache memory which, used as short-term fast buffer memory, stores data needed by programs, but also stores commands for shortening the access time, is generally manufactured using semiconductor technology and is mostly embodied as so-called read-write storage.

With non-volatile or permanent memories or storage media the memory content (i.e. the stored data) is held unchanged permanently or at least for a length of time (measured in years) on the storage medium without any supply of external energy such as an electrical supply voltage. Permanent memory or storage media for example includes storage based on semiconductor technology (such as Read-Only Memories (ROMs), Erasable Programmable Read-Only Memories (EPROMs), flash memory such as USB sticks or memory cards for digital cameras or mobile telephone, etc.); magnetic memory media (such as hard disks for example, as the external storage medium within a computer or computer is referred to, removable disks, which are connected to the computer via an external connection (e.g. USB, etc.) and, by contrast with the hard disk built into the computer, are transportable, diskettes, magnetic tapes, etc.) and optical storage media (such as CD-ROMs, DVDs, etc. for example).

For storage media or permanent storage a further distinction can be made between read-only, write-once and rewritable storage media. With read-only storage media such as ROMs, etc. for example, once a value is written to the medium it can no longer be changed, but only read out, which is why the medium is referred to as a read-only memory. On write-once storage media such as CD-ROMs, DVDs, etc. for example, data in the form of files can be stored once using a special write process in a suitable write device—the so-called “burner”, which involves a laser. The data stored on this storage medium can then only be read and can no longer be changed or removed from the storage medium. On rewritable storage media such as for example on a hard disk, etc. data can be written as well as read out by means of read access. In addition it is possible if necessary to overwrite data or files already present with new data or files or to remove data or files as required from the rewritable storage medium (“delete”), with the overwritten or deleted data being lost both through the overwriting and also through the deletion.

In everyday use, for the management, storage and archiving of data—mostly in the form of files—permanent, write-once or rewritable storage media such as CD-ROMs, DVDs, hard disks or removable disks, magnetic tapes or flash memory—above all in the form of USB sticks are used in particular. Ongoing development has seen a continuous increase and improvement in the storage capacity of storage media (e.g. hard disks, DVD, USB sticks), which has meant that, apart from an ageing of the physical data medium (e.g. semiconductor, magnetic or optical medium) the data is no longer transitory.

This means that sensitive information about people, known as personal information, is held unintentionally or deliberately, often for years on end, although possible statutory retention limits may have already expired. This data can thus also be illegally published and viewed in part or as a whole after the statutory retention period which represents a permitted storage period.

In addition the maintenance of time-limited usage rights e.g. to proprietary protected data such as ring tones, videos, text, cannot be really safeguarded. These usage rights can best be protected by statutory controls or contractual agreements, by which misuse can only be prevented with difficulty however.

In addition data of importance over the short term—especially that stored on rewritable storage media such as hard disks, is then no longer deleted and thus unnecessarily occupies storage space. This resulting increase in mixing important or current data with less important or outdated data can lead to the unintentional discarding of important information, if for example a number of versions of a file with different currency are stored on a storage medium at different locations in the file system. It can thus occur that not the most recent version of the file is worked on for example and this causes data to be lost.

There is naturally the possibility of automatically deleting data, such as sensitive information about persons after the statutory retention period has expired. Likewise only temporarily important information can be moved to specific directories—so called “temp folders” of the file system, which can then be manually or automatically cleared out at specific intervals, so that storage space is not occupied unnecessarily. For example Microsoft's operating system or File Manager software provides the option of automatic removal of files which have not been used for a long time, if for example the data stored on the storage medium (e.g. hard disk) has almost reached the storage capacity of said storage medium. In this process for example a user can also be asked or requested to have older files deleted automatically. The files are usually selected however according a creation date (i.e. that date, on which the file has been set up). In this case the oldest files are deleted first, without taking into account whether data, despite its age, should continue to be stored, e.g. because of its importance or because of statutory retention period requirements.

This process however has the disadvantage that, with manual deletion for example, sensitive data or data no longer needed can be overlooked or forgotten. This, data thus continues to be accessible or storage space is occupied by it. Since with personal data the statutory retention periods are often relatively long (e.g. in the region of years), it can also occur as a result of changes of data management or computer systems that for example an automatic deletion of the sensitive data after the statutory retention period has expired is no longer executed without problems and this data is thus not completely deleted.

Also the process of manual or automatic deletion can only be used for rewritable or overwritable storage media such as hard disks, removable disks, magnetic tapes, USB sticks, etc. or CD-ROMs or DVDS designed specifically for this purpose—so-called rewritable CD-ROMs or DVDs. Depending on the ageing of the physical data medium, data is retained on write-once data media for a relatively long period. Thus for example the predicted lifetime (i.e. the durability or readability of stored data) on a CD-ROM or DVD is estimated, depending on the respective storage, to be at least 10 to 50 years. Storage medium manufacturer Imation for example even guarantees a lifetime for its CD-ROMs and DVDs of at least 70 years given adherence to the specific environmental conditions and appropriate storage and handling (Imation: http://www.imation.de/products/pdfs/Zertifik CD R DVD Life.pdf; 2006).

However a method is known from publication US2003/0198892 A1 by which read access to data which is stored on CD-ROMs or DVDs for example can be time limited based on chemical processes. If the optical storage medium (e.g. CD-Rom, DVD, etc.) is removed from the packaging, the surface of the optical storage medium is changed by an oxidization process, which results in the data stored thereon only being able to be read out for appr. 48 hours. Thus these self-destruct storage media are not suitable for longer-term storage or archiving of data, but for example only to ensure adherence to time-limited usage rights of proprietarily protected data such as especially videos for example.

A further known method for safeguarding proprietarily protected data and for maintaining time-limited usage rights is what is known as Digital Rights Management (DRM). Through this method proprietary and marketing rights to intellectual property, above all film and sound recordings, but also to software or electronic books, can be preserved and billing options for licenses and rights created. With DRM the control of access to the data is implemented with the aid of cryptographic procedures. The data is stored encrypted on a content server or a storage medium for example and can be loaded from there by a user onto a computer. Only after a license, often with a time limit, has been requested from a license server, which is mostly linked to an authentication of the user, can the data be decrypted and thus used. However an executable program for the use of the data must be available on the user's computer so that the data can be decrypted.

Often free test versions of user programs or computer games which are downloaded from the Internet are realized using a similar principle for example. These are provided when downloaded with a time-limited usage license, after the expiry of which the user program or the computer game can no longer be used. However pure data such as video, music, text must be packed into an executable program however, before protection by means of a license is possible. To use the data a separate executable program would then again be necessary.

### SUMMARY OF INVENTION

An object of the present invention is thus to specify a procedure by which, in a simple manner and without the use of encryption methods, additional, expensive computer programs or methods, a timed availability of data on storage media is restricted and which is available for different storage media.

This object is achieved by a procedure for time-limited storage of data in files on storage media, with the data being provided with an expiry date when stored on a storage medium. The expiry date is then compared to the current date when the data is accessed by a read/write device. If the expiry date has been reached or exceeded, a predetermined action is then executed.

The inventive procedure thus enables data to be made unusable in a simple manner by a predetermined action for example if the expiry date has been reached or passed. In this way on the one hand sensitive information, such as personal data for example, is no longer available after expiry of a retention period, when for example the expiry date is equated with the end date of the retention period. On the other hand proprietary and marketing rights for digital data can be protected in a simple manner without additional use of license servers or executable programs to be installed.

A preferred development of the invention makes provision, when the expiry date is reached or passed, for the data to be irrevocably deleted from the storage media. In this way it is ensured that sensitive data is deleted reliably e.g. after the end of the retention period and civil rights as well as regulation of the data protection are adhered to in this regard. By deleting “expired” files that were only temporarily important for example, an unnecessary occupation of storage capacity is also prevented.

It is also useful, if, on reaching or exceeding the expiry date, the data is moved into an encrypted file store and then access to this data is only possible with a special authorization. Instead of deleting the “expired” data, this is stored in an encrypted file store and is thus ideally still available to authorized users.

Furthermore it is recommended that identifying features belonging to a be are expanded by the expiry date and then the expiry date be stored on the storage medium along with the identifying features belonging to the file. This easily allows each file, when it is stored, to be provided with an expiry date (e.g. “never”, “after <period>”, “on <date>”) as well as a name. The expiry date is then be stored along with the other identifying features such as the file name, the file type and the parameters supplied by the file system, such as file size, creation date for example. The data stored in the file can then be uniquely assigned to an expiry date.

A preferred embodiment of the invention makes provision, in parallel to the checking of the expiry date, for a date that the data stored on a storage medium was last accessed for reading/writing to be compared with the current date, which enables possible attempts at manipulation (e.g. resetting of the current date in the computer system) to be detected. If such an attempt at manipulation is identified, since a few entries are files in the future, access to the data on the storage medium can be prevented.

It is advantageous for the current date for the comparison with the expiry date to be provided available by the read/write facility of an operating system, with operating system being taken to mean programs for the operation of a digital computer, such as programs for managing the resources (e.g. CPU working time, main memory” etc.), for error handling or for executing I/O operations. The file system is likewise a part of the operating system. The operating system also provides the system time which generated by the computer hardware for the various programs available on the computer and which as a rule corresponds to the respective current time of day applicable in the time zone and thus to the current date. By using the date supplied by the operating system there is no longer any necessity to enter the current date for the comparison, which makes the opportunities for manipulation considerably more difficult.

It is also useful for the read/write facility to log the current date supplied by the operating system in a non-volatile memory, since this allows access to expired data by manipulation of the hardware or system time to be prevented. The current date is written for each access to a file identified by an expired date to be written by the read/write facility (e.g. storage access controller) into a non-volatile memory and an overwriting of the memory is for example only enabled by hardware encoding if the date to be written is more recent than the date stored.

### BRIEF DESCRIPTION OF THE DRAWINGS

The invention will be explained in greater detail below by way of examples with reference to the enclosed FIGURE.

FIG. 1 shows the schematic execution sequence of the inventive procedure, which is started with step 1.

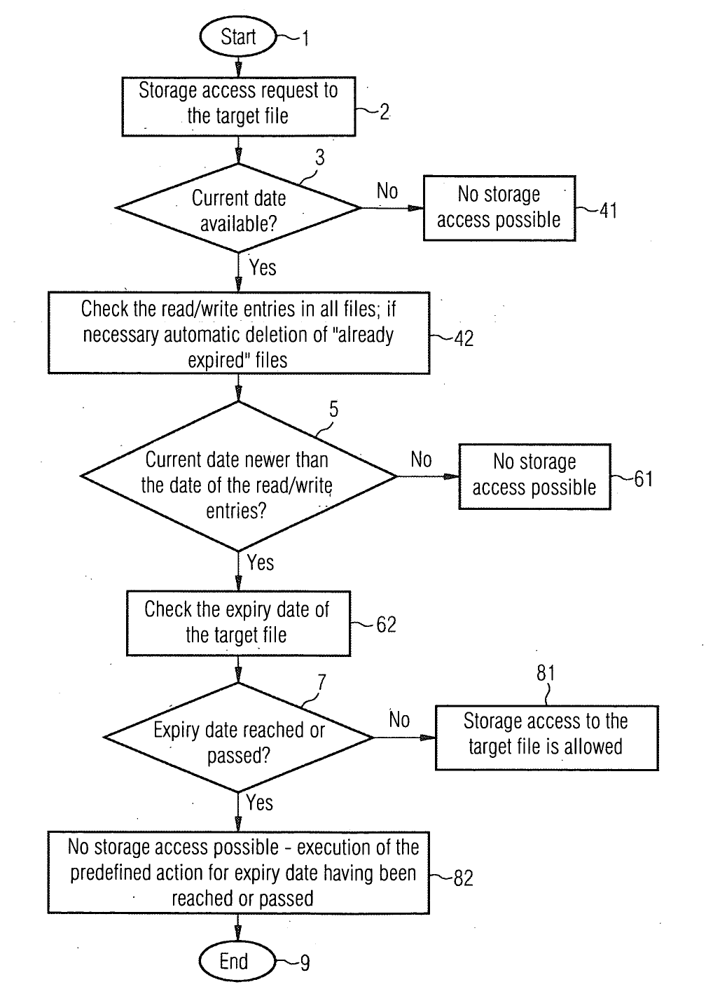

### DETAILED DESCRIPTION OF INVENTION

In a second procedure step 2 a read/write facility requests access to data stored on a target file. This data stored in a target file is stored on a storage medium (e.g. a hard disk, a CD-ROM, a DVD, etc.) in the structure of a file system such as a folder for example.

In a third procedure step 3 a check is then made as to, whether a current date is available and correct. The current date or the current time in this case is made available to a storage access controller by an operating system of the respective computer on which the inventive procedure is employed. The storage access controller in such cases is mostly that hardware/firmware component of the read/write device by which the read or write accesses to the respective storage media are monitored. In order to prevent any possible manipulation of the hardware or of the system date made available by the operating system, the respective current date can also be written on an ongoing basis by the storage access controller into a non-volatile memory, in which case a corresponding hardware encoding only allows an overwriting if the system date supplied by the computer system is newer than the date in non-volatile memory.

If it is now established in third procedure step 3 that the current date supplied by the operating system is older than that date which is stored in the non-volatile memory of the storage access controller, in a fourth procedure step 41 access to the memory is denied and the procedure is ended and if necessary a warning message is triggered.

If however the current date is available and correct—i.e. newer than that date which is stored in the non-volatile memory of the storage access controller, in a fifth procedure step 42 a creation date or a date of a last read/write access is checked for each individual file on the storage medium. In this fifth procedure step 42 data in files which have already “expired” can be automatically deleted if necessary.

In a sixth procedure step 5 the creation date or the date of the last read/write access of the individual files are compared with the current date which was supplied by the operating system to safeguard them against possible manipulation. A manipulation is recognized for example through the fact that an entry of a creation date or of a date of the last to read/write access has a date in the future—i.e. for the current date has been reset for example.

If such manipulation is detected, then in a seventh procedure step 61 access to the data which is stored on the storage medium is not permitted. Additional actions defined for this, such as destruction, deletion or encryption of the data can be carried out.

If no manipulation is established, then in an eighth procedure step 62 the checking of the expiry date of the target file in which the requested data is stored on the storage medium is requested. The expiry date in this case is stored as an identification attribute belonging to the target file in the file system on the storage medium—as is also the case with identifying features such as the file name, file size, etc. For example “never”, a specific period or a specific date can typically be entered as the expiry date via a management interface to the operating system by a user.

In a ninth procedure step 7 the expiry date of the target file is then compared with the current date supplied by the operating system. If the expiry date has not yet been reached or is exceeded, in a tenth procedure step 81 access is allowed to the data stored in the target file.

However if the expiry date has been reached or passed—i.e. the expiry date is the same as the current date or older than the current date, then in an 11th procedure step 82 storage access is blocked and a predetermined action is also performed. Depending on the storage medium, the deletion of the target file can be executed for example as the predetermined action. It is however also possible for the target file to be moved into a specific file store (folder) of the file system, to which access is only possible with a specific authorization. Depending on the storage medium it is also conceivable for the target file to be encrypted—i.e. for the existing target file to be replaced on the storage medium by an encrypted variant of the target file, whereby access to the target file is only possible with special authorizations. With a CD-ROM it is also conceivable for the stored data to be destroyed by overburning of the table of contents for example.

After the predetermined action has been performed the process is ended with a twelfth procedure step 9.

To ensure a safe implementation of the procedure for time-limited storage of data on storage media, a further standardization of an encryption/decryption module with mandatory checking of the time expiry is proposed. This data encryption prevents the data being read out in normal—i.e. not protected by automatic control and deletion—read devices, such as CD-/DVD drives etc. for example. In this way even storage media such as CD-ROMs, DVD, USB sticks, etc., which as pure storage media do not themselves (yet) have access to the scheduling logic of the inventive procedure, can only be read out in protected read/write devices, on which the scheduling logic is implemented.

A further inventive embodiment allows the expiry date to be checked and if necessary actions initiated not only on access to the file itself but also with other file checks. This is done for example within the context of a check on the files of the file system for computer viruses. An expansion of the computer programs available for this purpose—known as a virus scanners—is conceivable for example and can be implemented technically without any special outlay.

As an alternative or in addition the transmission of expired files can also be prevented by a query about the expiry date of files being made by switching processors—known as routers—or gateways, etc. However in the event of the expiry date having been reached or passed, a transmission of the file or the files can be prevented or for example the file or the files can be encrypted to prevent misuse.

1.-6. (canceled)

7. A method for time-limited storage of data on storage media, comprising:
providing the data with an expiry date when stored as a file on the storage medium;
expanding identifying features belonging to the file by the expiry date;
storing the expiry date on the storage medium together with the identifying features belonging to the file;
comparing the expiry date with a current date when this data is accessed by a read/write facility; and
initiating a predetermined action when the expiry date is reached or passed.

8. The method as claimed in claim 7, wherein when the expiry date is reached or passed, the data is irrevocably deleted from the storage.

9. The method as claimed in claim 7, wherein when the expiry date is reached or passed the data is moved into an encrypted file store and access to this data is then only possible with special authorization.

10. The method as claimed in claim 7, wherein in parallel to the checking or the expiry date, a date when read/write accesses were last performed on the data stored on the storage medium is compared with the current date.

11. The method as claimed in claim 8, wherein in parallel to the checking or the expiry date, a date when read/write accesses were last performed on the data stored on the storage medium is compared with the current date.

12. The method as claimed in claim 9, wherein in parallel to the checking or the expiry date, a date when read/write accesses were last performed on the data stored on the storage medium is compared with the current date.

13. The method as claimed in claim 7, wherein the current date to be compared with the expiry date by the read/write facility is made available of an operating system.

14. The method as claimed in claim 8, wherein the current date to be compared with the expiry date by the read/write facility is made available of an operating system.

15. The method as claimed in claim 9, wherein the current date to be compared with the expiry date by the read/write facility is made available of an operating system.

16. The method as claimed in claim 10, wherein the current date to be compared with the expiry date by the read/write facility is made available of an operating system.

17. The method as claimed in claim 11, wherein the current date to be compared with the expiry date by the read/write facility is made available of an operating system.

18. The method as claimed in claim 12, wherein the current date to be compared with the expiry date by the read/write facility is made available of an operating system.

19. The method as claimed in claim 13, wherein the current date supplied by the operating system is logged in a non-volatile memory.

20. The method as claimed in claim 14, wherein the current date supplied by the operating system is logged in a non-volatile memory.

21. The method as claimed in claim 15, wherein the current date supplied by the operating system is logged in a non-volatile memory.

22. The method as claimed in claim 16, wherein the current date supplied by the operating system is logged in a non-volatile memory.

23. The method as claimed in claim 17, wherein the current date supplied by the operating system is logged in a non-volatile memory.

24. The method as claimed in claim 18, wherein the current date supplied by the operating system is logged in a non-volatile memory.
